(19) United States
(12) Patent Application Publication
(10) Pub. No.: US 2008/0272596 A1
(43) Pub. Date: Nov. 6, 2008

(54) WIND TURBINE VARIABLE SPEED TRANSMISSION

(76) Inventor: Edward T. House, Springfield, MO (US)

Correspondence Address: THE SMALL PATENT LAW GROUP LLP, 225 S. MERAMEC, STE. 725T, ST. LOUIS, MO, 63105, US

(21) Appl. No.: 12/114,637

(22) Filed: May 2, 2008

Related U.S. Application Data
(60) Provisional application No. 60/927,266, filed on May 2, 2007.

(51) Int. Cl. F03D 11/02; F03D 9/00; F16H 59/06

(52) U.S. Cl. 290/44; 290/52; 474/23

(57) ABSTRACT

A wind turbine variable speed transmission is provided. The wind turbine includes a rotor, an RPM amplifier coupled to the rotor and a variable speed transmission clutch coupled to the RPM amplifier. The wind turbine further includes a generator coupled to the variable speed transmission clutch and configured to generate power from a rotation of the rotor.

### CROSS REFERENCE TO RELATED APPLICATIONS

This application claims priority to and the benefit of the filing date of U.S. Provisional Application No. 60/927,266 filed May 2, 2007 for “WIND TURBINE VARIABLE SPEED TRANSMISSION,” which is hereby incorporated by reference herein in its entirety.

### BACKGROUND OF THE INVENTION

This invention relates generally to power generating wind turbines, and more particularly, to a variable speed transmission system for power generating wind turbines.

Power generating wind turbines typically include a planetary transmission coupled between the wind turbine rotor and the wind turbine generator. In electric power generating wind turbines, a planetary transmission efficiency is typically about 85%. These planetary transmissions are usually three speed transmissions that have to be monitored and operated by additional electronics. This loss of 15% in efficiency in the transmission is reflected in the output efficiency of the entire electric generating wind turbine, resulting in a lower kilowatt output.

### BRIEF DESCRIPTION OF THE INVENTION

Various embodiments of the present invention provide a transmission for power generating wind turbines including a variable speed transmission clutch, which may be a variable speed electromagnetic clutch transmission clutch or a variable speed belt drive transmission clutch.

In one exemplary embodiment, a wind turbine is provided that includes a rotor, an RPM amplifier coupled to the rotor and a variable speed transmission clutch coupled to the RPM amplifier. The wind turbine further includes a generator coupled to the variable speed transmission clutch and configured to generate power from a rotation of the rotor.

In another exemplary embodiment, a variable speed transmission for a wind turbine is provided that includes a first single belt variable speed drive pulley and a first double belt variable speed drive pulley connected to the first single belt variable speed drive pulley. The variable speed transmission further includes a second double belt variable speed drive pulley connected to the first double belt variable speed drive pulley and a second single belt variable speed drive pulley connected to the second double belt variable speed drive pulley.

### BRIEF DESCRIPTION OF THE DRAWINGS

FIG. 1 is a block diagram showing a variable speed transmission clutch configuration within an electric power generating wind turbine in accordance with various embodiments of the invention.

FIG. 2 is a perspective view of a belt driven variable speed drive pulley transmission constructed in accordance with an embodiment of the invention.

FIG. 3 is another perspective view of the belt driven variable speed drive pulley transmission of FIG. 2.

FIG. 4 is another perspective view of the belt driven variable speed drive pulley transmission of FIG. 2.

FIG. 5 is a graph of rotor horsepower output versus rotor RPM power output.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional or operational blocks of various embodiments, the functional or operational blocks are not necessarily indicative of the division or arrangement between hardware circuitry or physical components. Thus, for example, one or more of the operational blocks (e.g., sensor or controller) may be implemented in a single piece of hardware or may be rearranged. Similarly, the operational blocks may be stand alone components, may be incorporated in other components, or may be incorporated as part of other systems. Thus, it should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

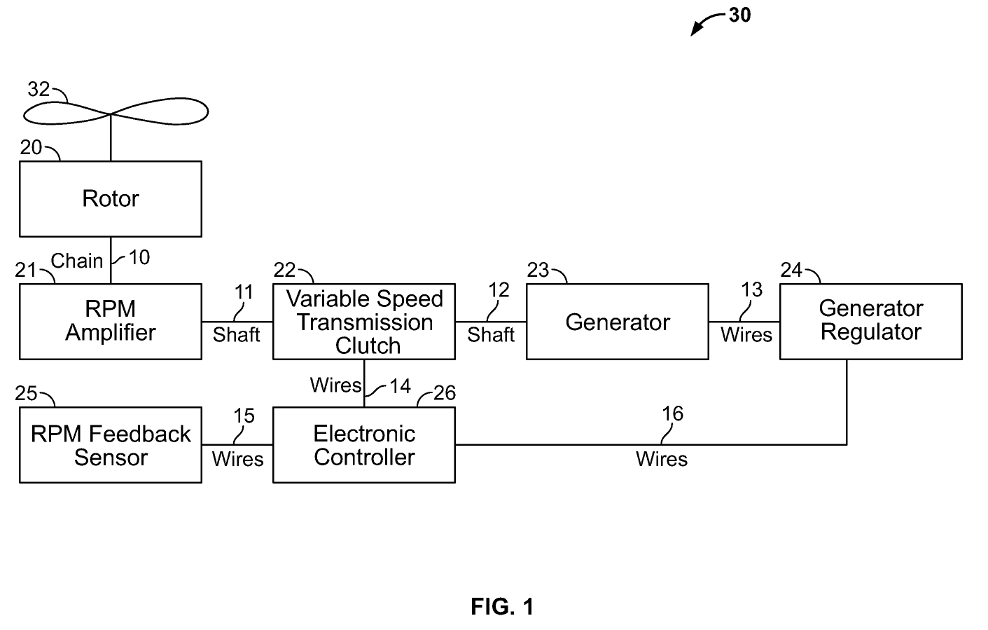

Referring to FIG. 1, one exemplary embodiment of the invention provides a wind turbine 30 having a variable speed transmission clutch 22 with a shaft 11 coupled to one side or end of the variable speed transmission clutch 22 and a shaft 12 coupled to an opposing side or end of a variable speed transmission clutch 22. However, it should be noted that the orientation or positioning of the shaft 11 and/or the shaft 12 may be changed or modified as desired or needed.

The shaft 11 is coupled to a Revolutions Per Minute (RPM) amplifier 21, for example, an amplifying gear arrangement that includes in one embodiment two gears and a chain configured to increase the RPM of the shaft 11 in the following manner: When the maximum rotor RPM (X) is, for example, 30 RPMs, and the needed RPM (Y) of a generator 23, for example, a wind turbine generator connected to the variable speed transmission clutch 22 by the shaft 12, is for example, 1,800 RPMs, then the formula used to calculate the size of the needed gear ratio is as follows: Y/X=Z. In this example, Z is 60, so the opposing gears in the gear set for this example require a 60:1 ratio. In one embodiment, a larger of the opposing gears is located on a chain 10 on the side of a rotor 20 and the smaller of the opposing gears is on the chain 10 on the side of the RPM amplifier 21, thereby allowing the trailing components to travel at a speed sixty times faster than the rotor 20. Thus, the chain 10 is connected between the rotor 20 and the RPM amplifier 21.

In operation, the arrangement of the variable speed transmission clutch 22 opposingly coupled to the shaft 12, and the shaft 12 coupled to the wind turbine generator 23, allows the variable speed transmission clutch 22 to vary the speed of the generator 23 independent of the speed at which the rotor 20 and RPM amplifier 21 are rotating. An electronic controller 26 electronically connected to the variable speed transmission clutch 22 via wires is able to regulate the variable speed electromagnetic transmission clutch 22, thereby allowing the wind turbine 30 to produce peak amounts of electricity, limited only by the raw horsepower of one or more rotor blades 32.

In various embodiments, the generator 23 is electronically coupled to a generator regulator 24 via wires 13, thereby allowing the generator regulator 24 to provide a required amount of voltage and amperage into the “grid” lines. The electronic controller 26 also is electronically coupled via wires 15 to an RPM feedback sensor 25 that provides an input feedback and the generator regulator 24 is electronically coupled via wires 16 to the generator regulator 24. This feedback and control arrangement keeps the system performing at peak levels of output.

It should be noted that the variable speed transmission clutch 22 may be provided in different configurations. For example, the variable speed transmission clutch 22 may be any magnetically coupled control that is frequency independent, for example, operates independently from the speed of a motor. As an example, the variable speed electromagnetic control may be a magnetic-coupled variable speed belt drive available from Coyote Electronics of Fort Worth, Tex. However, the various embodiments are not limited to a magnetic-coupled variable speed belt drive, but instead may include a belt driven variable speed drive pulley transmission, such as described in co-pending and commonly owned U.S. patent application Ser. No. 11/580,492, which is hereby incorporated by reference in its entirety.

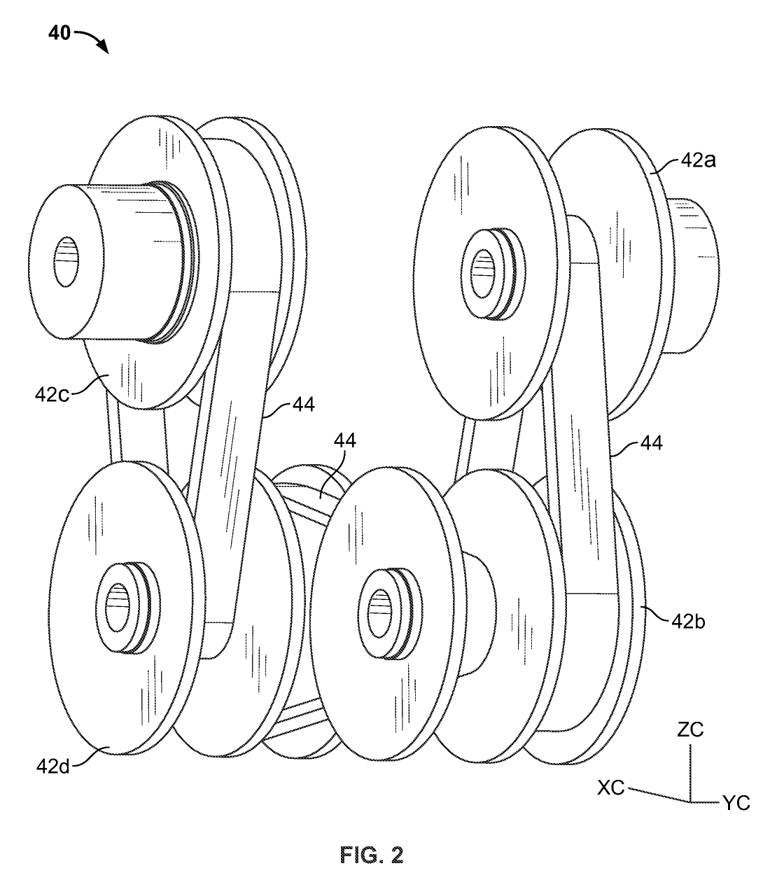

As an example, and in accordance with one embodiment, a belt driven variable speed drive pulley transmission 40 as shown in FIGS. 2 through 4 may be provided. A plurality of variable speed drive pulleys 42, which in this embodiment includes four variable speed drive pulleys 42, are configured as opposing sets of pairs of variable speed drive pulleys 42a, 42b and 42c, 42d with each set linked via belts 44. Moreover, one of each of the variable speed drive pulleys 42b and 42d of each set is a double variable speed drive pulley (e.g., double idler pulley) and are linked by a belt 44. By varying a pitch diameter ratio of the sets of variable speed drive pulleys 42, the gear/torque ratios are changed.

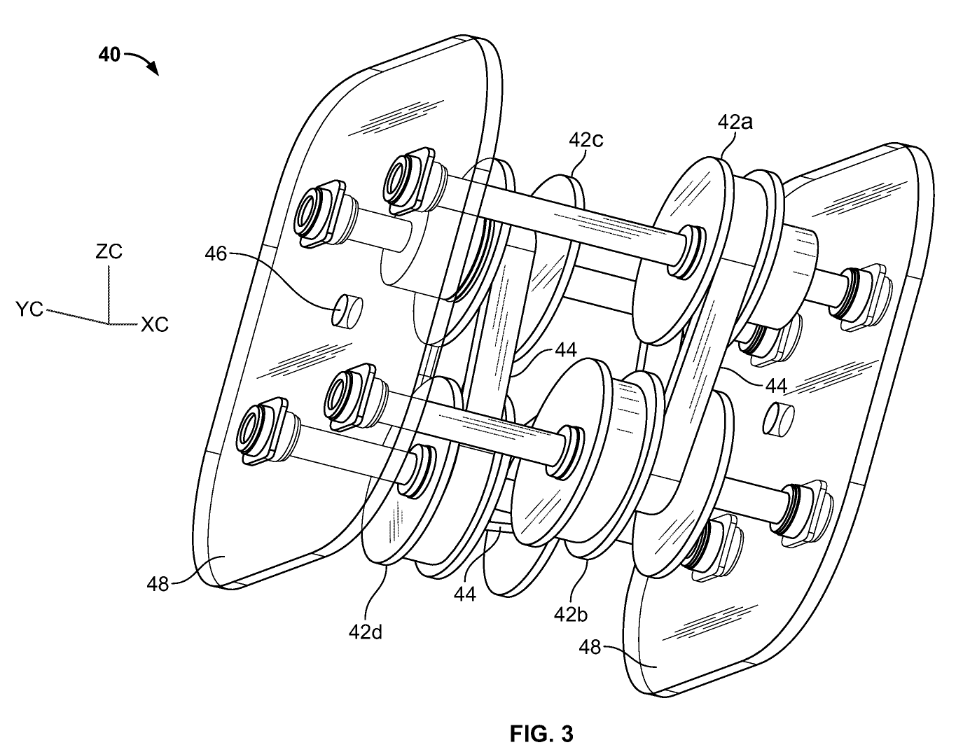

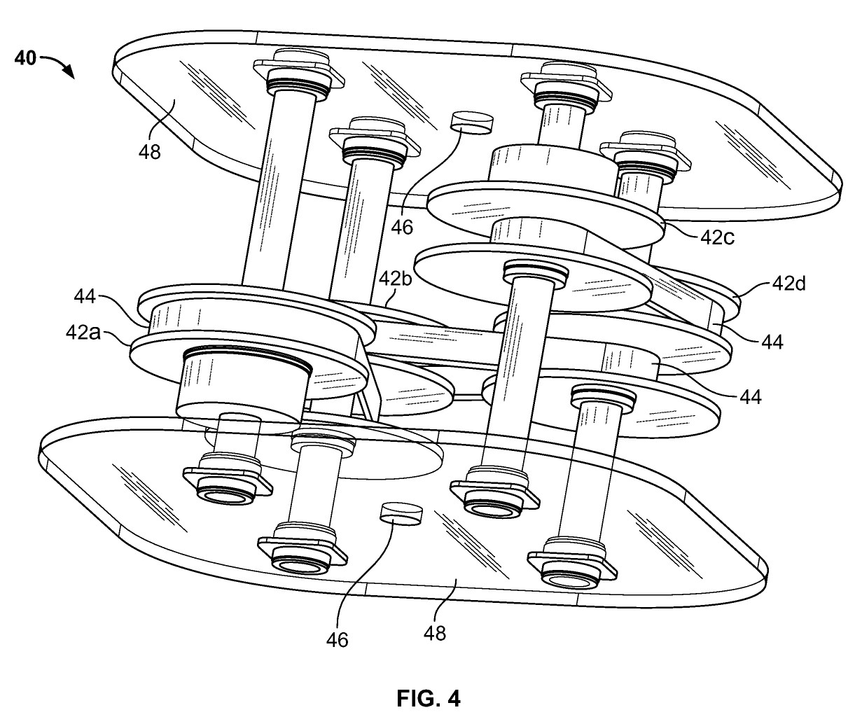

In various embodiments, an opening 46 is provided within mounting plates 48 as shown in FIGS. 3 and 4 and that receive therein a shaft (e.g., the shaft 11 and/or shaft 12 shown in FIG. 1). When mounted with the wind turbine 30 (shown in FIG. 1), the belt driven variable speed drive pulley transmission 40 may be oriented or positioned such that the entire structure is rotated forty-five degrees relative to a horizontal plane or other reference plane and a diamond shaped profile or configuration is thereby provided. However, it should be noted that other orientations are contemplated, such as rotated at different angles, for example, to provide a square profile or configuration. It also should be noted that the various embodiments are not limited to the four variable speed drive pulleys 42 as shown, but more or less than four variable speed drive pulleys 42 may be provided such that the total number of variable speed drive pulleys 42 may be, for example, 3, 6, 7, 8, etc. Also, additional belts per pair of variable speed drive pulleys 42 may be provided, such as three belts, five belts, etc.

It also should be noted that the various components of the wind turbine 30 may be changed, modified or replaced. For example, the generator 23 may be replaced with an alternator that outputs DC or AC current. Additionally, and for example, the chain 10 and shafts 11 and 12 may be combined or may be replaced with different arrangements, such as a belt drive, a chain only drive, different combinations thereof, a coupled gear arrangement, a direct gear to gear arrangement, etc.

In operation the wind turbine 30 follows the horsepower of the rotor blades 32 and not the RPMs of the rotor blades 32. Accordingly, and for example, if the rotor 20 operates at 1800 RPM at seven miles per hour (MPH) to produce seven horsepower (HP) of output, the variable speed transmission clutch 22 allows the needed RPM to be achieved at a lower wind speed (e.g., seven MPH versus twenty MPH) by varying the gear/torque ratio. Moreover, the variable speed drive pulleys 42 may be configured to slip to reduce the RPM to, for example, a maximum or peak RPM rating of the generator 23.

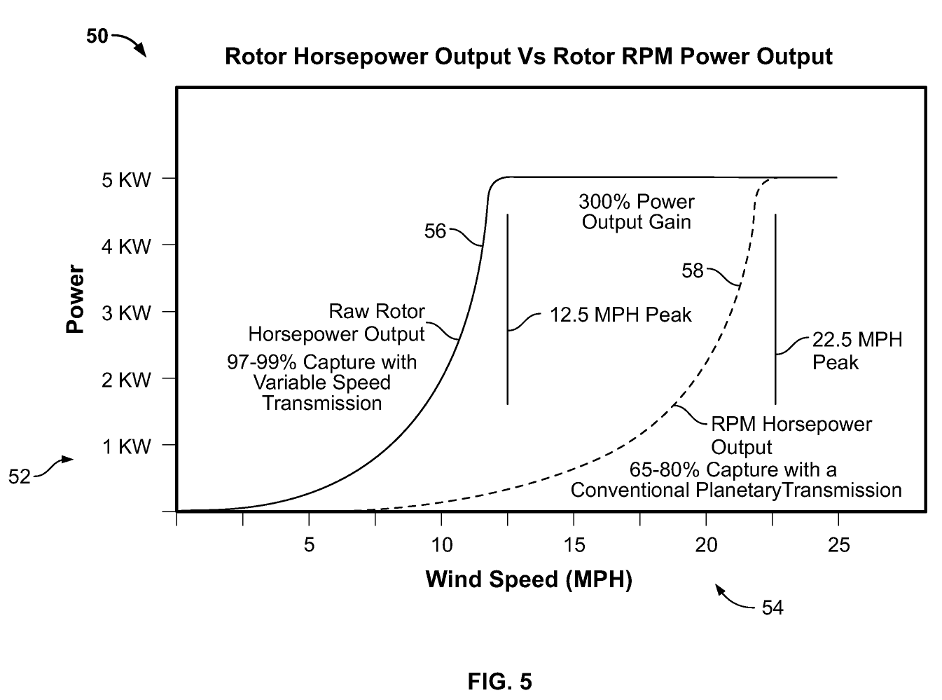

Thus, the various embodiments increase the efficiency of transmitting power from the wind turbine rotor to the wind turbine generator. In the case of electric power generation, the efficiency can be from 85% to 97%, thereby increasing the kilowatt output proportionally. For example, as shown in the graph 50 of rotor horsepower output versus rotor RPM power output illustrated in FIG. 5, wherein horsepower is plotted on the vertical axis 52 and wind speed in MPH is plotted on the horizontal axis 54, the raw rotor horsepower output by various embodiments of the invention is represented by the curve 56 and the raw rotor horsepower of a conventional planetary transmission is represented by the curve 58. As can be seen, the various embodiments can provide a 300% power output gain over the conventional planetary transmission. Moreover, peak rotor speed is achieved at a much lower wind speed, for example 12.5 MPH instead of 22.5 MPH. Accordingly, the various embodiments provide a substantial gain in transmission efficiency in a power generating wind turbine that results in a substantial increase in kilowatt output of, for example, an electric power generating wind turbine.

While particular embodiments of the invention have been shown and described, it will be obvious to those skilled in the art that changes and modifications may be made without departing from the various embodiments of the invention in its broader aspects. For example, the chain and gears that increase RPM ratios can be located on either the input side or output side of the variable speed transmission clutch.

Some embodiments of the present invention provide a machine-readable medium or media having instructions recorded thereon for a processor or computer to operate, for example, controllers or sensors of the various embodiments to perform one or more embodiments of the methods described herein, such as to provide feedback or control information. The medium or media may be any type of CD-ROM, DVD, floppy disk, hard disk, optical disk, flash RAM drive, or other type of computer-readable medium or a combination thereof.

The various embodiments and/or components, for example, the components and/or controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claim is:

1. A wind turbine comprising:
a rotor;
an RPM amplifier coupled to the rotor;
a variable speed transmission clutch coupled to the RPM amplifier; and
a generator coupled to the variable speed transmission clutch and configured to generate power from a rotation of the rotor.

2. A wind turbine in accordance with claim 1 further comprising an electronic controller coupled to the variable speed transmission clutch and a generator regulator coupled to the generator.

3. A wind turbine in accordance with claim 1 further comprising an RPM feedback sensor coupled to the electronic controller.

4. A wind turbine in accordance with claim 1 wherein the variable speed transmission clutch comprises a magnetic-coupled variable speed belt drive.

5. A wind turbine in accordance with claim 1 wherein the variable speed transmission clutch comprises a belt driven variable speed drive pulley transmission.

6. A wind turbine in accordance with claim 1 wherein the RPM amplifier is coupled to the rotor via a chain.

7. A wind turbine in accordance with claim 1 wherein variable speed transmission clutch is coupled to each of the RPM amplifier and the generator via a respective shaft.

8. A wind turbine in accordance with claim 1 wherein (i) the RPM amplifier is coupled to the rotor and (ii) the variable speed transmission clutch is coupled to each of the RPM amplifier and the generator via one of a belt drive, chain drive, coupled gear arrangement and direct gear to gear arrangement.

9. A wind turbine in accordance with claim 1 wherein the generator comprises an alternator.

10. A wind turbine in accordance with claim 1 wherein the variable speed transmission clutch is not a planetary drive system.

11. A wind turbine in accordance with claim 1 wherein the variable speed transmission clutch is configured to operate based on a horsepower of the rotor and not an RPM of the rotor.

12. A variable speed transmission for a wind turbine, the variable speed transmission comprising:
a first single belt variable speed drive pulley;
a first double belt variable speed drive pulley connected to the first single belt variable speed drive pulley;
a second double belt variable speed drive pulley connected to the first double belt variable speed drive pulley; and
a second single belt variable speed drive pulley connected to the second double belt variable speed drive pulley.

13. A variable speed transmission in accordance with claim 12 wherein the variable speed drive pulleys are arranged in a square configuration.

14. A variable speed transmission in accordance with claim 12 wherein the variable speed drive pulleys are arranged in a diamond shaped configuration.

15. A variable speed transmission in accordance with claim 12 further comprising a shaft connected to at least one of the first single belt variable speed drive pulley and the second single belt variable speed drive pulley.

16. A variable speed transmission in accordance with claim 15 further comprising a chain link connecting the shaft to at least one of the first single belt variable speed drive pulley and the second single belt variable speed drive pulley.

17. A variable speed transmission in accordance with claim 12 wherein at least one of the variable speed drive pulleys includes at least three belts.

18. A variable speed transmission in accordance with claim 12 wherein the variable speed drive pulleys are configured to operate based on a horsepower of a blade of the wind turbine and not an RPM of the blade.
